(19) United States
(12) Patent Application Publication
(10) Pub. No.: US 2026/0140271 A1
(43) Pub. Date: May 21, 2026

(54) SEMICONDUCTOR X-RAY DETECTOR WITH LIGHT EMITTING LAYER AND FIBER OPTIC PLATE

(71) Applicant: Carl Zeiss X-ray Microscopy, Inc., Dublin, CA (US)

(72) Inventors: Martin KRENKEL, Aalen (DE); Xiaochao XU, Pleasanton, CA (US)

(21) Appl. No.: 19/388,039

(22) Filed: Nov. 13, 2025

Related U.S. Application Data
(60) Provisional application No. 63/722,901, filed on Nov. 20, 2024.

(51) Int. Cl. G01T 1/24

(52) U.S. Cl. CPC G01T 1/248; G01T 1/244

(57) ABSTRACT

An X-ray detector comprising a semiconductor detector layer coupled with a light-emitting diode (LED) layer on the optical side. The detector features an X-ray-side electrode layer deposited on one side of the semiconductor detector layer and an optical-side electrode layer, such as transparent Indium Tin Oxide (ITO), on the opposite side. The semiconductor detector layer is composed of a high atomic number (Z) material with high density and electrical resistivity (around or larger than 10<sup>6</sup>Q·cm) to effectively absorb X-ray radiation while minimizing dark current. A fiber optic plate is used to guide the light generated in the LED layer to an optical detector.

### RELATED APPLICATIONS

This application claims the benefit under 35 USC 119(e) of U.S. Provisional Application No. 63/722,901, filed on Nov. 20, 2024, which is incorporated herein by reference in its entirety.

### BACKGROUND OF THE INVENTION

X-ray microscopy provides high spatial resolution two and three dimensional imaging of samples. Implicit in this technology is the need for high X-ray detection efficiency.

Some current X-ray microscopes utilize optical coupling of a thin scintillator X-ray detector to a charge coupled device (CCD) or complementary metal oxide semiconductor (CMOS) camera via an optical microscope. This setup enables high-resolution imaging by first converting the X-ray to light and then detecting the light with conventional cameras.

The optical coupling in scintillator-optical microscope-camera detection systems is not perfect, however. The light collection efficiency is limited because of the finite objective numerical aperture (NA) and light loss in the optical microscope. This results in a reduction in Detective Quantum Efficiency (DQE) for the X-ray detection (the so-called quantum sink) and the direct consequence is a reduction in the imaging throughput.

In the typical collection process, scintillator detection systems lose most of the generated light photons. For example, a 40× objective with NA=0.65 collects about 3% of the light generated by the scintillator and a lower NA objective collects even less. As a rough estimate, the system with a 0.65-NA objective and high efficiency optical and camera system can collect about 40 photoelectrons from an X-ray photon of 30 keV and often these photoelectrons are collected in several neighboring pixels. While numerical aperture could be increased to increase collection efficiency, this comes at the expense of depth of field, which translates to a less scintillator thickness and thus X-ray absorption efficiency.

An alternative method employs a fiber optic plate to couple the scintillator directly to the optical detector. Fiber optic plates consist of numerous fine glass fibers, each functioning as an individual optical waveguide. These fibers facilitate the direct transfer of light from the scintillator's emission plane to the detection plane of the CMOS, for example, optical detector chip, effectively transmitting the generated image with high spatial fidelity.

The fiber optic coupling aims to enhance light collection efficiency by reducing the optical losses typically associated with lens-based systems. Each fiber in the plate maintains the spatial resolution by channeling light from a specific point in the scintillator to a corresponding point on the CMOS detector. This direct coupling minimizes the spreading of light and preserves the integrity of the image, which is crucial for high-resolution X-ray microscopy.

Another option for detecting X-rays or high energy particle beams utilizes semiconductor direct conversion detection materials. Materials, such as silicon (Si), gallium arsenide (GaAs), cadmium telluride (CdTe), perovskite structure semiconductors, or other active materials, is used instead of a scintillator. The absorption of an X-ray photon creates an electron-hole pair cloud, and the free charge carriers are then directed to a pixelated electronic detector via the application of a bias voltage. Multiple electron-hole pair clouds can be integrated and read out, or individual charge cloud pulses can be detected and counted. Silicon based directly detection detectors are only useful for low X-ray energies (e.g. <20 keV) because of the low stopping power of silicon. For harder X-ray radiation, the photon-counting detectors with high-atomic number semiconductor, such CdTe and GaAs are used, which are comparatively expensive.

For example, in U.S. Pat. Appl. Publ. Nos. US 2021/0311211 A1 and US 2023/0165541 A1, by Xiaochao Xu and Christoph Graf Vom Hagen, which are incorporated herein by this reference, the free charge carriers are directed to a spatial light modulator, such as a liquid crystal (LC) light valve. The electrical charge of the carriers modulate the light valve, which is then illuminated by an external light source of an optical microscope. This configuration can mitigate the loss of light in the optical system over the current scintillator-optical microscope-camera detection systems.

More recently, WO 2023/133491 A1, entitled Semiconductor X-ray Detector with Light Emitting Layer and Method Therefor, by Philipp Brenner and Xiaochao Xu, which is incorporated herein by this reference, describes a detector that combines a light emitting diode (LED) emission layer in a direct-converting detector in X-ray microscopes. The semiconductor material is coated so that the electron-hole pairs create visible light in an LED layer, which is then observed with the classical optical path of an X-ray microscope. One major benefit is that a thick active material can be used and it is still possible, to achieve high resolution since light generation only occurs in the LED layer. Resolution and sensitivity are therefore no longer coupled. However, in an X-ray microscope, the LEDs are typically observed through microscope objectives, so only small detection areas are common.

### SUMMARY OF THE INVENTION

The present invention concerns the use of X-ray LED detectors such as in large-area X-ray detectors. The X-ray LED detector is coupled to a fiber optic plate, which then is further connected to a classical detector for visible light such as a CMOS or CCD optical sensor.

In general, according to one aspect, the invention features an X-ray detector comprising a semiconductor detector layer configured to absorb X-ray radiation and generate charge carriers in response thereto, the semiconductor detector layer having an X-ray side and an optical side, an X-ray-side electrode layer disposed on the X-ray side of the semiconductor detector layer, a light-emitting diode (LED) layer disposed on the optical side of the semiconductor detector layer, the LED layer configured to receive charge carriers from the semiconductor detector layer and emit light, an optical-side electrode layer disposed on the LED layer opposite the semiconductor detector layer, the optical-side electrode layer comprising a transparent conductive material, a fiber-optic faceplate (FOP) optically coupled to the optical-side electrode layer, the FOP configured to guide emitted light while preserving spatial resolution, and a spatially resolved sensor positioned to receive light guided by the FOP and generate an image corresponding to the X-ray radiation distribution.

In examples, the semiconductor detector layer comprises a high atomic number (Z) semiconductor material selected from the group consisting of silicon, amorphous selenium (a-Se), gallium arsenide (GaAs), cadmium zinc telluride (CdZnTe), cadmium telluride (CdTe), and perovskite semiconductor crystals. The semiconductor detector layer often has a thickness ranging from about 2 micrometers to about 10 millimeters.

The spatially resolved sensor often comprises a two-dimensional pixelated CMOS or CCD chip.

In addition, an immersion oil layer can be positioned between the FOP and the optical-side electrode layer to enhance optical coupling through adhesion and refractive index matching.

In some embodiments, the FOP has fiber diameters significantly smaller than the pixel size of the spatially resolved sensor to maintain high imaging resolution.

A tapered FOP can also be configured to adjust the effective pixel size by magnifying or demagnifying the image.

Usually, the FOP is made of lead glass with a thickness sufficient to protect the spatially resolved sensor from X-ray radiation.

Additionally, multiple modules of the detector can be tiled together to form a larger active area, each module having its own bias voltage supply and LED layer.

In general, according to another aspect, the invention features an method of detecting X-ray radiation comprising absorbing X-ray photons in a semiconductor detector layer to generate charge carriers, applying an electric field across the semiconductor detector layer using an X-ray-side electrode layer and an optical-side electrode layer, transporting at least one type of charge carrier to a light-emitting diode (LED) layer disposed on the optical side of the semiconductor detector layer, injecting the charge carriers into the LED layer to cause radiative recombination and emit light, guiding the emitted light through a fiber-optic faceplate (FOP) to a spatially resolved sensor, and detecting the guided light with the spatially resolved sensor to generate an image corresponding to the X-ray radiation distribution.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIGS. 1A and 1B are side views showing semiconductor light emitting diode (LED) X-ray detectors with fiber optic plates coupling;

FIG. 2 is a side schematic perspective view showing the layers of an exemplary a GaAs detector/LED/FOP device; and

FIG. 3 is a schematic diagram of an X-ray microscope to which the present invention is applicable.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Also, all conjunctions used are to be understood in the most inclusive sense possible. Thus, the word “or” should be understood as having the definition of a logical “or” rather than that of a logical “exclusive or” unless the context clearly necessitates otherwise. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

It will be understood that although terms such as “first” and “second” are used herein to describe various elements, these elements should not be limited by these terms. These terms are only used to distinguish one element from another element. Thus, an element discussed below could be termed a second element, and similarly, a second element may be termed a first element without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

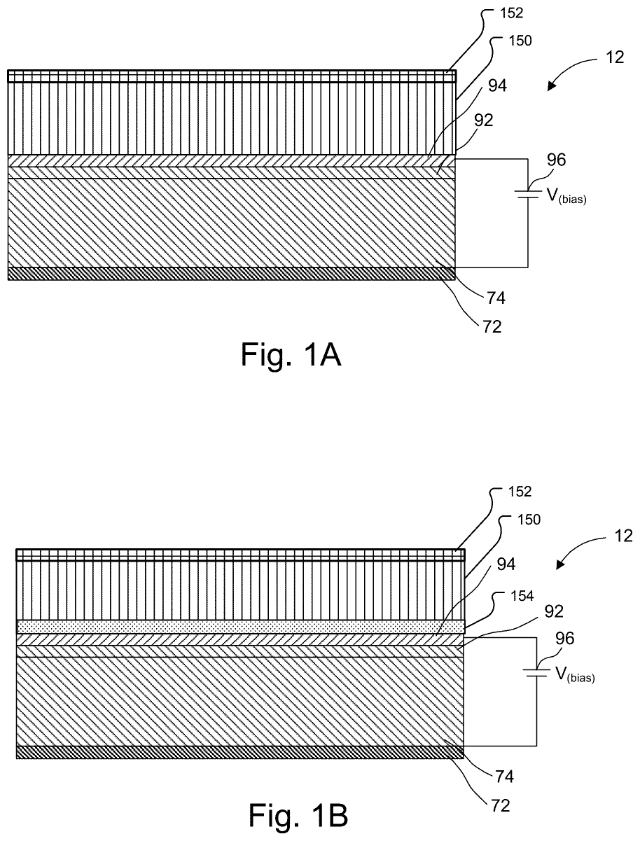

FIG. 1A shows the basic arrangement of semiconductor light emitting diode (LED) X-ray detector 12.

The detector 12 comprises LED layer 92 disposed on one side of a semiconductor detector layer 74. An X-ray-side electrode layer 72 is deposited on an X-ray side of the semiconductor detector layer 74. On an optical-side of the semiconductor detector layer 74 is the LED layer 92 followed by an optical-side electrode layer 94 such as a transparent Indium Tin Oxide (ITO) layer.

The semiconductor detector layer 74 is generally a semiconductor having a relatively high effective atomic number Z and density to effectively stop and absorb the X-ray radiation. The electrical resistivity should be high with a value of around or larger than 10⁶ Q·cm to reduce the dark current. In addition, at least one type of the excited charge carriers (electrons or holes) can be transported through the thickness of the semiconductor layer 74 before it recombines in the absorption layer, i.e. the excited charge carrier that is used for injection into the LED layer 92 has a relatively high mobility-lifetime product μτ. This is one property of a semiconductor material, in which μ is the mobility of the material; and τ is lifetime of the carriers. Larger μτ is preferred for better detector performance. Other requirements are similar to those required with other semiconductor X-ray detectors, such as low polarization and stability over time and other conditions.

The semiconductor layer 74 will often have a thickness in the range of about a few micrometers (such as between 2 and 5 micrometers) to 10 mm. In one embodiment the semiconductor layer 74 is between approximately 0.5 and 2 mm. That said, a thicker layer is better for higher energy. In different embodiments, this layer is silicon, amorphous selenium (a-Se), GaAs, CdZnTe, CdTe, or crystalline and amorphous perovskite semiconductor crystal materials (ABX3).

A fiber-optic faceplate (FOP) 150 guides the light generated by the LED layer 92 to create a large-area X-ray detector. With the X-ray LED, an FOP coupled X-ray detector can potentially improve one or both quantum efficiency and imaging resolution (with the fiber diameter unchanged).

A spatially resolved sensor 152 detects the light from the fiber-optic faceplate 150. The sensor 152 is preferably a two-dimensional pixelated CMOS or a CCD chip. In particular, sensors that are preconnected to an FOP 150 can be used, and the X-ray LED 92 can be simply placed on the sensor by pressing it against the FOP 150 via a holding device such as a clamp to enable the coupling of the light generated in the LED layer 92 into the individual waveguides of the FOP 150.

To image the X-ray radiation distribution generated in the LED layer 92 with sufficient resolution, a FOP is chosen in which fiber diameter is significantly smaller than the pixel size of the sensor 152. For example, there are FOPs with fiber diameters in the range of 3 or 6 μm, which could be used for pixel sizes in the range of, for example, 25 μm or larger for the sensor 152. Of course, significantly larger sensor pixel sizes in the range of, for example, 50, 100, or 200 μm or larger are also useable with these small fiber sizes.

The working mechanism is as follows. A charge cloud (cloud of electron-hole pairs) is created within the thick semiconductor layer 74 by absorption of the X-ray photons or particles. The electrons and holes travel in opposite directions due to the applied electric field though the X-ray-side electrode layer 72 and the optical-side electrode layer 94 by bias voltage source 96. The voltage provided by the voltage source is usually high, such as greater than 10-20 Volts (V). Currently, for semiconductor layer of 2 mm thickness, the voltage is greater than 100 V such as 200-300 V or more.

One of the charge carrier types is injected into a thin emission zone of the LED layer 92 based on the polarity of the voltage source 96. The LED layer 92 structure is tailored for effective radiative recombination. See Li N, Han K, Spratt W, Bedell S, Ott J, Hopstaken M, et al. Ultra-low-power sub-photon-voltage high-efficiency light-emitting diodes. Nature Photonics. 2019; 13(9):588-592. The radiative recombination results in the emission of a photon in the optical wavelengths such as a visible light photon, which propagates through the optical-side electrode layer 94 and can then be guided to the optical detector 152 by the FOP 150.

An important requirement for the LED layer 92 is that it operates efficiently over a wide range of charge carriers that are injected into the layer. The amount of charge carriers injected depends on the amount of absorbed X-ray photons and thus varies throughout operation. Special layer stacks and growth conditions must be considered in order to ensure efficient operation at low charge carrier injection densities. See Li, et al.

Advantages exist when organic light emitting diode (OLED) layer is used for the LED layer 92. OLEDs exhibit high efficiencies at low charge carrier injection densities while an efficiency roll-off is usually observed at high charge injection densities. Another advantage of using an OLED is that the layers can be deposited by thermal evaporation on different absorber substrates as no lattice matching has to be taken into account as it is the case for epitaxial techniques which must be applied for inorganic semiconductors.

In one embodiment, the detector 12 uses a GaAs based semiconductor detector absorber layer 74. For the LED layer 92, its related alloys, AlGaAs and InGaAs are used to form a heterostructure. One advantage of GaAs is that it has one of the largest radiative recombination rates among commonly available semiconductor materials. In addition, because of its wide availability, the technologies for making such LEDs are mature and easily available.

The LED based detector will cover a wide range of X-ray flux levels, when the flux level is low, or for single photon detection, the X-ray generated current in the detector is rather small. A typical LED has a rather low light efficiency when the driving current is low because non-radiative recombination overtakes radiative recombination at low charge injection rate.

In one example, the LED layer 92 is designed for high efficiency at ultra-low current to overcome the shortcomings of regular LEDs that designed to work at higher injection currents. A single quantum well (QW) is used with a specially designed well and cladding, in one embodiment. The improvements are achieved via two mechanisms: (1) a high-quality InGaAs/InGaP or GaAs/InGaP interface reduces the interface recombination velocity (IRV) and (2) large valence band offset

$${Q}_{v} = \frac{Δ {E}_{v}}{( Δ {E}_{v} + Δ {E}_{c} )}$$

to make hole density p much larger than electron density n within the QW (or large conduction band offset

$${Q}_{c} = \frac{Δ {E}_{c}}{( Δ {E}_{v} + Δ {E}_{c} )}$$

to make electron density n much larger than hole density p within the QW). See Li, et al.

In another example, the LED layer 92 has a InGaP/GaAs/InGaP double heterojunction, which have been demonstrated for high quantum efficiency. See Li, et al. In one specific example, the InGaP band gap is 1.90 eV, and the InGaP/GaAs conduction band offset is 0.10 eV and valence band offset 0.38 eV.

The spatial distribution of light generated in LED layer 92 is then maintained by the FOP 150 as it is transferred to the individual pixels of the sensor 152.

FIG. 1B shows an alternative coupling option. An immersion oil (or other immersion medium) layer 154 is used between the FOP 150 and the X-ray LED and specifically the transparent electrode 94 so that it adheres to the FOP 150 by adhesion. The layer 154 also provides refractive index-matching (e.g., refractive index of the layer 154 is within ±0.15 of the FOP entrance face) The thickness of the layer 154 is often 1-50 μm. Especially when using pixel sizes that are significantly larger (e.g. 100 μm sensor pixel size) than the typical size of the visible light generation spot in the LED layer (e.g. <20 μm), there is no disadvantage in that the generated light must propagate larger distances in the electrode layer or immersion oil. The blur introduced by the additional immersion oil layer will still be smaller than the sensor pixel size and the FOP transmission will not introduce any significant additional blur.

One way to influence the effective area of the X-ray detector is to use tapered FOPs, which can effectively reduce or enlarge the image generated by the X-ray LED, to control the effective pixel size of the X-ray detector in a desired direction. For example, there are tapered FOPs that have a (de)magnification of a factor of 4, which could be used to couple a large area X-ray LED to a smaller sensor. Alternatively, the tapered FOP could be mounted in the other direction, to enlarge the resolution, e.g. to achieve 25 μm effective pixel size with real 100 μm pixels. In this way, the tapered FOP can be used to deal with any mismatch between Xray and optical detector sizes.

One disadvantage of active semiconductor materials is that they typically cannot be produced with large dimensions. Typical dimensions for a single crystal perovskite are in the range of about 50 millimeters (mm). To anyway achieve active area sizes in the range of several hundred millimeters, multiple smaller elements can be tiled together to fill the larger areas of the optical sensors or the FOP. The several modules can have their own connectors to supply the bias-voltage and their own LED layer. Alternatively, single electrodes in front and back of the active material and a single led layer could be used. The tiling typically will introduce small gaps between the modules, for example due to non-ideal edge properties. The influence of these edge effects in the X-ray image will be noticeable as changed sensitivity of the respective pixels at the transitions, which can be compensated by a flat-field correction, i.e. by recording one or more images without any object and compensating for static deviations in the images. When multiple images for different exposure conditions (e.g. different read-out time, different attenuation due to prefilters) are used, non-linear behavior of pixels can also be compensated.

One preferred way to build an FOP-based detector with X-ray LED is to use fiber optic plates made of lead glass. By choosing the thickness of the lead glass FOP, the typically radiation-sensitive sensor can be protected against the X-ray radiation. The thicker the FOP, the higher the X-ray energies the detector can withstand.

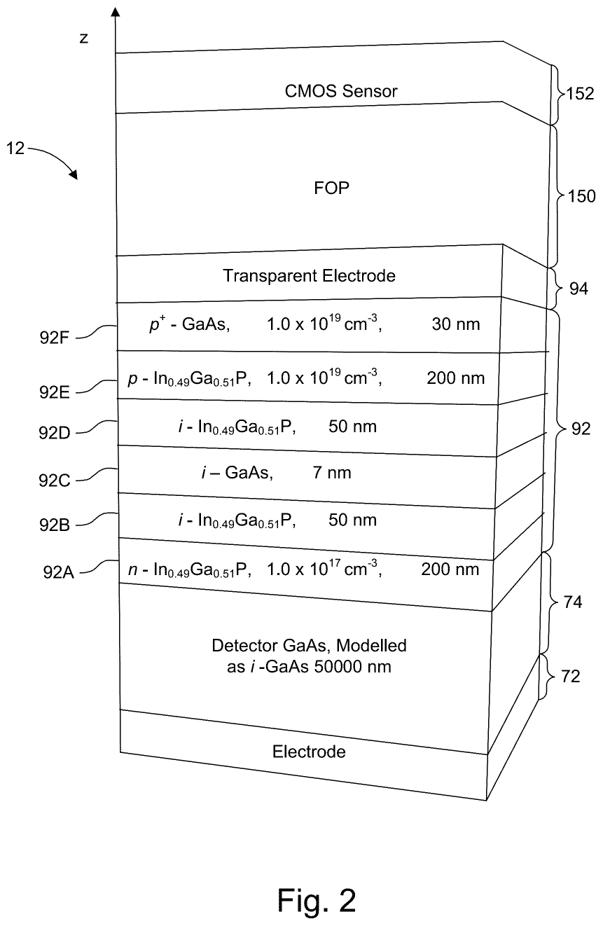

FIG. 2 shows one specific embodiment of the detector 12.

The semiconductor detector absorber layer 74 is a thick GaAs layer for detecting X-ray. The thick GaAs layer is typically between 0.1 to over 100 microns thick. (Note, however, for simulation purposes, a thickness of 50 μm was used.) It is located on the X-ray-side electrode layer 72. The LED heterostructure layer 92 includes an n type In_{0.49}Ga_{0.51}P contact layer 92A of 200 nanometers (nm), followed by an In_{0.49}Ga_{0.51}P layer 92B of 50 nm, a GaAs layer 92C layer of 7 nm, and another In_{0.49}Ga_{0.51}P layer 92D of 50 nanometers to form a double heterojunction. A p type In_{0.49}Ga_{0.51}As hole contact layer 92E of 200 nm thickness and a p+ GaAs hole contact layer 92F of 30 nm thickness are used before the optical-side electrode layer 94.

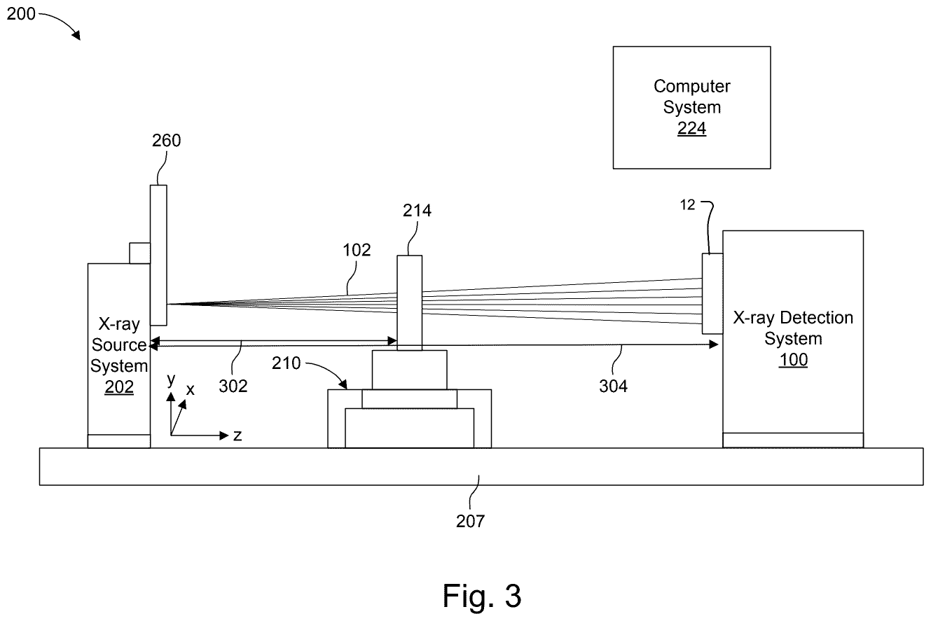

For context, FIG. 3 is a schematic diagram of an X-ray CT microscopy system 200 to which the X-ray detection system 100 and its semiconductor LED X-ray detector 12 are applicable.

Nevertheless, the present invention is applicable to charged particle analysis systems and non-microscopy systems.

The microscope 200 generally includes an X-ray imaging system that has an X-ray source system 202 that generates a polychromatic that is then filtered or possibly monochromatic X-ray beam 102 and an object stage system 210 with object holder 212 for holding an object 214 and positioning it to enable scanning of the object 214 in the stationary beam 102. The X-ray detection system 100 detects the beam 102 after it has been modulated by the object 214. A base such as a platform or optics table 207 provides a stable foundation for the microscope 200.

In general, the object stage system 210 has the ability to position and rotate the object 214 in the beam 102.

The source system 102 may be any kind of radiation source with a suitable energy or energy-range, such as an open or closed X-ray tube with transmission or reflection targets. Also, other kinds of X-ray sources like synchrotron radiation are possible.

The X-ray beam generated by source 202 is preferably conditioned to suppress unwanted energies or wavelengths of radiation especially when using the laboratory X-ray source. For example, undesired wavelengths present in the beam are eliminated or attenuated, using, for instance, energy filters (designed to select a desired X-ray wavelength range (bandwidth)) held in a filter wheel 260. Conditioning is also often provided by collimators or condensers and/or an X-ray lens such as a zone plate lens.

When the object 214 is exposed to the X-ray beam 102, the X-ray photons transmitted through the object form a modulated X-ray beam that is received by the detection system 100. In some other examples, a zone plate objective X-ray lens is used to form an image onto X-ray detection system 100.

Typically, a magnified projection image of the object 214 is formed on the detection system 100. The geometrical magnification is equal to the ratio of the source-to-detector distance 304 and the source-to-object distance 302.

The operation of the system 200 and the scanning of the object 214 is controlled by a computer system 224 that often includes an image processor subsystem, a controller subsystem. The computer system is used to set bias voltages of the detector 12 and to readout the optical images detected by the sensor 152 of the detection system 100. The computer system 224, with the possible assistance of its image processor, accepts the set of images from the detection system 100 associated with each rotation angle of the object 214 to build up the scan.

It should be noted that the computer system need not be a unitary device. For example, a single-board computer or microcontroller might be used to as the control system for the microscopy system 200. A separate computer might be used to process the images generated by the sensor 152 to generate the spatially and spectrally resolved object images or projections of the object and/or perform tomographic reconstruction of the object based on the various projections. In fact, the sensor images might be stored and then later processed or reprocess in order to generate the object images and reconstructions. As a result, a special purpose computer such as a graphic processing unit (GPU), application specific integrated circuit (ASIC), field programmable array (FPGA), general purpose computer or some combination of these or other computer systems would be included as part of the computer system 224 to process the images. In addition, these computer systems could also be integrated within the x-ray detection system 100.

While this invention has been particularly shown and described with references to preferred embodiments thereof, it will be understood by those skilled in the art that various changes in form and details may be made therein without departing from the scope of the invention encompassed by the appended claims.

What is claimed is:

1. An X-ray detector comprising:
a semiconductor detector layer configured to absorb X-ray radiation and generate charge carriers in response thereto, the semiconductor detector layer having an X-ray side and an optical side;
an X-ray-side electrode layer disposed on the X-ray side of the semiconductor detector layer;
a light-emitting diode (LED) layer disposed on the optical side of the semiconductor detector layer, the LED layer configured to receive charge carriers from the semiconductor detector layer and emit light;
an optical-side electrode layer disposed on the LED layer opposite the semiconductor detector layer, the optical-side electrode layer comprising a transparent conductive material;
a fiber-optic faceplate (FOP) optically coupled to the optical-side electrode layer, the FOP configured to guide emitted light while preserving spatial resolution; and
a spatially resolved sensor positioned to receive light guided by the FOP and generate an image corresponding to the X-ray radiation distribution.

2. The X-ray detector of claim 1, wherein the semiconductor detector layer comprises semiconductor material selected from the group consisting of silicon, amorphous selenium (a-Se), gallium arsenide (GaAs), cadmium zinc telluride (CdZnTe), cadmium telluride (CdTe), and perovskite semiconductor crystals.

3. The X-ray detector of claim 1, wherein the semiconductor detector layer has a thickness ranging from about 2 micrometers to about 10 millimeters.

4. The X-ray detector of claim 1, wherein the spatially resolved sensor comprises a two-dimensional pixelated CMOS or CCD chip.

5. The X-ray detector of claim 1, further comprising an immersion oil layer positioned between the FOP and the optical-side electrode layer to enhance optical coupling through adhesion.

6. The X-ray detector of claim 1, wherein the FOP has fiber diameters significantly smaller than the pixel size of the spatially resolved sensor to maintain high imaging resolution.

7. The X-ray detector of claim 1, wherein the FOP is a tapered fiber-optic faceplate configured to adjust the effective pixel size by magnifying or demagnifying the image such as between 0.25× and 4×.

8. The X-ray detector of claim 1, wherein the FOP is made of lead glass with a thickness sufficient to protect the spatially resolved sensor from X-ray radiation.

9. The X-ray detector of claim 1, wherein multiple modules of the detector are tiled together to form a larger active area, each module having its own bias voltage supply and LED layer.

10. A method of detecting X-ray radiation, comprising:
absorbing X-ray photons in a semiconductor detector layer to generate charge carriers;
applying an electric field across the semiconductor detector layer using an X-ray-side electrode layer and an optical-side electrode layer;
transporting at least one type of charge carrier to a light-emitting diode (LED) layer disposed on the optical side of the semiconductor detector layer;
injecting the charge carriers into the LED layer to cause radiative recombination and emit light;
guiding the emitted light through a fiber-optic faceplate (FOP) to a spatially resolved sensor; and
detecting the guided light with the spatially resolved sensor to generate an image corresponding to the X-ray radiation distribution.

11. The method of claim 10, further comprising enhancing optical coupling between the LED layer and the FOP by applying an immersion oil layer.

12. The method of claim 10, wherein the semiconductor detector layer is composed of a high-Z material with high electrical resistivity and mobility-lifetime product (μτ) to ensure efficient charge carrier transport and reduced dark current.

13. The method of claim 10, further comprising using a tapered FOP to adjust the effective pixel size by magnifying or demagnifying the emitted light image.

14. The method of claim 10, wherein the FOP is made of lead glass to protect the spatially resolved sensor from X-ray exposure.

15. The method of claim 10, further comprising tiling multiple detector modules to cover a larger area and compensating for edge effects through flat-field correction techniques.
